(19) United States
(12) Patent Application Publication
(10) Pub. No.: US 2020/0139758 A1
(43) Pub. Date: May 7, 2020

(54) BICYCLE HUB APPARATUS

(71) Applicant: CHING-SHU CHEN, Changhua (TW)

(72) Inventor: CHING-SHU CHEN, Changhua (TW)

(73) Assignee: CHOSEN CO., LTD., CHANGHUA (TW)

(21) Appl. No.: 16/182,221

(22) Filed: Nov. 6, 2018

(51) Int. Cl. B60B 27/04; F16D 41/36; B60B 27/02

(52) U.S. Cl. CPC B60B 27/047; F16D 41/36; B60B 27/023; B60B 2900/3312; B60B 2900/212; B60B 2900/321; B60B 2900/351

(57) ABSTRACT

A bicycle hub apparatus may comprise a wheel hub, a freewheel and a driving base. The freewheel comprises a first chainwheel and a second chainwheel, a first elastic piece, and a second elastic piece. A lateral surface of the first chainwheel comprises a first teeth while a lateral surface of the second chianwheel has a third teeth, and the first teeth is configured to engage with the third teeth to have a synchronous rotation in clockwise direction. Also, the other lateral surface of the first chainwheel has a second teeth while the other lateral surface of the second chainwheel comprises a fourth teeth such that when the first chainwheel and the second chainwheel are rolled over, the second teeth is adapted to engage with the fourth teeth to have a synchronous rotation in counterclockwise direction.

### FIELD OF THE INVENTION

The present invention relates to a bicycle hub apparatus and more particularly to a bicycle hub apparatus that enables a freewheel to install on either of two lateral sides of a bicycle.

### BACKGROUND OF THE INVENTION

Referring to FIG. 12, a conventional bicycle hub apparatus comprises a first wheel hub (50), a driving base (60) and a first freewheel (70) is installed between the first wheel hub (50) and the driving base (60). The first freewheel (70) has a chainwheel (71), a first sprocket (72) and two elastic pieces (73). A first teeth (711) formed on one surface of the chainwheel (71) is coupled in the first wheel hub (50) through one elastic piece (73), and a second teeth (721) formed on one surface of the first sprocket (72) is coupled in the driving base (60) through the other elastic piece (73). Thus, when the wheel hub (50) is connected to the driving base (60), the chainwheel (71) and the first sprocket (72) are faced each other, and the two elastic pieces (73) are configured to respectively push the chainwheel (71) and the first sprocket (72) outwardly to engage the first teeth (711) with the second teeth (721). When the driving base (60) is rotated forwardly, it is configured to drive the first wheel hub (50) so as to drive a bicycle forwardly. On the other hand, when the driving base (60) is rotated backwardly, the second teeth (721) of the first sprocket (72) is adapted to detach from the first teeth (711) of the chainwheel (71) so as to have self-rotation. As a result, the bicycle is only driven when the driving base (60) is rotated forwardly.

Nevertheless, the bicycle hub apparatus mentioned above has its shortcoming that either of the first teeth (711) or the second teeth (721), which are configured to engage together, can only be formed at one side of the chainwheel (71) or the first sprocket (72), so that, generally, the driving base (60) can only be installed at the right side of the first wheel hub (50), which enables a bicyclist to pedal forwardly to move a bicycle forward. In case that the driving base (60) and the first wheel hub (50) switch positions. When a bicyclist pedals forwardly, the driving base (60) is adapted to have a counterclockwise rotation relative to the first wheel hub (50), which leads that the second teeth (721) of the first sprocket (72) detaches from the first teeth (711) of the chainwheel (71) so as to have self-rotation.

So that, referring to FIGS. 13 and 14, another conventional bicycle hub apparatus is developed that comprises a second wheel hub (80) and a second freewheel (90). The second wheel hub (80) has a shaft (81) axially penetrating through a center portion of the second wheel hub (80), and the shaft (81) has a plurality of bearings (811) disposed thereon. When the shaft (80) penetrates through the second wheel hub (80), the bearings (811) are configured to couple with an inner periphery of the second wheel hub (80). Also, the inner periphery close to an end of the second wheel hub (80) has a locating base (82), and a plurality of concave portions and convex portions are alternatively arranged along an inner periphery of the locating base (82). A driving ring (83) having a concave-convex outer periphery (831) is coupled at an inner periphery of the locating base (82), and also the driving ring (83) comprises a concave-convex inner periphery (832). The second freewheel (90) comprises a second sprocket (91) and a base (92), and a plurality of slots (93) are formed on the base (92), and each of the slots (93) has a spring (94) and a teeth (95) installed therein. The base (92) installed in the second wheel hub (80) is located inside the driving ring (83), and the teeth (95) is borne against by the spring (94) to bear against the concave-convex inner periphery (832) of the driving ring (83). Moreover, each of two ends of the second wheel hub (80) has engage with a locating nut to secure the components thereof.

When the second freewheel (90) is rotated forwardly, the teeth (95) is configured to bear against the concave-convex inner periphery (832) of the driving ring (83) so as to drive the second wheel hub (80) to have rotation in the same direction. On the contrary, when the second freewheel (90) is stopped, the second wheel hub (80) is not driven the second freewheel (90) to have rotation. In case that sides of a left chain and a right chain of a performance bicycle need to be switched, a bicyclist can just switch the positions of the spring (94) and the teeth (95) of the base (92) to achieve the chains switch.

However, the conventional bicycle hub apparatus is disadvantageous because: when the left chain and the right chain of the bicycle have been switch-sided and the second freewheel (90) is detached from the second wheel hub (80), each pair of the spring (94) and the teethes (95) in the slot (93) has to switch positions too, and there are a number of springs and teethes need to be side-switched, which is inconvenient, high risk of missing parts, and time-wasting, and also bicyclist may be hurt by cutting edges of the spring (94) during switching process. Therefore, there remains a need for a new and improved design for a bicycle hub apparatus to overcome the problems presented above.

### SUMMARY OF THE INVENTION

The present invention provides a bicycle hub apparatus which comprises a wheel hub, a freewheel and a driving base. The wheel hub has a housing formed at an end thereof, and a shaft axially penetrates through the housing to pivotally connect to the wheel hub. Also, a connecting section formed at an inner periphery of the housing has a non-circular cross-section, and a driving ring is coupled with the connecting section in the housing. The driving ring has a concave-convex inner periphery. The freewheel comprises a first chainwheel and a second chainwheel, a first elastic piece, and a second elastic piece. A lateral surface of the first chainwheel comprises a first teeth while a lateral surface of the second chianwheel has a third teeth, and the first teeth is configured to engage with the third teeth to have a synchronous rotation in clockwise direction. Also, the other lateral surface of the first chainwheel has a second teeth while the other lateral surface of the second chainwheel comprises a fourth teeth such that when the first chainwheel and the second chainwheel are rolled over, the second teeth is adapted to engage with the fourth teeth to have a synchronous rotation in counterclockwise direction.

The first elastic piece and the second elastic piece are formed in disc shape. The first elastic piece has a plurality of first abutting portions at one lateral surface thereof, and each of the first abutting portions formed in flat shape and extended from an edge of the first elastic piece is connected to a first elastic portion which axially protrudes from the other lateral surface of the first elastic piece. Similarly, the second elastic piece comprises a plurality of second abutting portions at one lateral surface thereof, and each of the second abutting portions formed in flat shape and extended from an edge of the second elastic piece is connected to a second elastic portion which axially protrudes from the other lateral surface of the second elastic piece. The first abutting portions and the second abutting portions are respectively abutted against the first chainwheel and the second chainwheel at the lateral sides which are not engaged. Also, outer peripheries of the first chainwheel and the second chainwheel are respectively formed in a concave-convex first driving surface and a concave-convex second driving surface. The first driving surface is configured to engage with the inner periphery of the driving ring. The driving base is disposed on the shaft of the wheel hub, and a driving gear is formed at an outer periphery of the driving base. Moreover, a driving opening axially penetrating through the driving base comprises a concave-convex inner periphery. The driving opening is configured to engage with the second driving surface of the second chainwheel, and a nut is locked on the shaft to abut against and limit a position of the driving base.

In one embodiment, the concave-convex inner periphery of the driving ring is configured to match and engage with the concave-convex first driving surface of the first chainwheel.

In another embodiment, the driving opening having the concave-convex inner periphery is adapted to match and engage with the concave-convex second driving surface of the second chainwheel.

In still another embodiment, the outer periphery of the first chainwheel has mark R and L thereon respectively located close to the first teeth and the second teeth while the outer periphery of the second chainwheel has mark R and L thereon respectively located close to the third teeth and the fourth teeth.

In a further embodiment, a locating ring is tightly coupled in the housing at a front end thereof so as to limit a position of the driving ring in the connecting section.

Comparing with conventional bicycle hub apparatus, the present invention is advantageous because: (i) because of the first chainwheel and the second chainwheel having the first teeth, the second teeth, the third teeth, and the fourth teeth, the wheel hub can be installed at the left or the right side of the bicycle, which is convenient; (ii) the first elastic piece and the second elastic piece respectively have the first abutting portion and the second abutting portion which are flat, and the first abutting portions and the second abutting portions are respectively and evenly borne against at outer surfaces of the first chainwheel and the second chainwheel, which improves the engagement of the first chainwheel and the second chainwheel and prevents the first chainwheel and the second chainwheel from being damaged by the first elastic portion and the second elastic portion; and (iii) the first driving surface and the inner periphery of the driving ring, and the second driving surface and the driving opening respectively have concave-convex peripheries, which enhances the engagement between the first driving surface and the inner periphery of the driving ring and between the second driving surface and the driving opening and prevent the parts from wearing or stuck by sharp edges, thereby achieving the effect of stable and safe riding.

### BRIEF DESCRIPTION OF THE DRAWINGS

FIG. 1 is a three-dimensional assembly view of a bicycle hub apparatus of the present invention.

FIG. 2 is a three-dimensional exploded view of the bicycle hub apparatus of the present invention.

FIG. 3 is a schematic assembly view illustrating a first teeth of a first chainwheel is engaged with a third teeth of a second chainwheel of the bicycle hub apparatus in the present invention.

FIG. 4 is a sectional assembly view illustrating a driving base is installed at a right side of a wheel hub of the bicycle hub apparatus and has clockwise rotation in the present invention.

FIG. 5 is a sectional view of FIG. 4 along line A-A.

FIG. 6 is a sectional view of FIG. 4 along line B-B.

FIG. 7 is a schematic view illustrating the driving base installed at the right side of the wheel hub is cooperated with a sprocket of the bicycle hub apparatus in the present invention.

FIG. 8 is a schematic view illustrating the first teeth of the first chainwheel is disengaged with the third teeth of the second chainwheel when the driving base is installed at the right side of the wheel hub and has counterclockwise rotation in the present invention.

FIG. 9 is a schematic assembly view illustrating a second teeth of the first chainwheel is engaged with a fourth teeth of the second chainwheel of the bicycle hub apparatus in the present invention.

FIG. 10 is a sectional assembly view illustrating the driving base is installed at a left side of the wheel hub of the bicycle hub apparatus and has counterclockwise rotation in the present invention.

FIG. 11 is a schematic view illustrating the driving base installed at the left side of the wheel hub is cooperated with the sprocket of the bicycle hub apparatus in the present invention.

FIG. 12 is a prior art.

FIG. 13 is a prior art.

FIG. 14 is a prior art.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

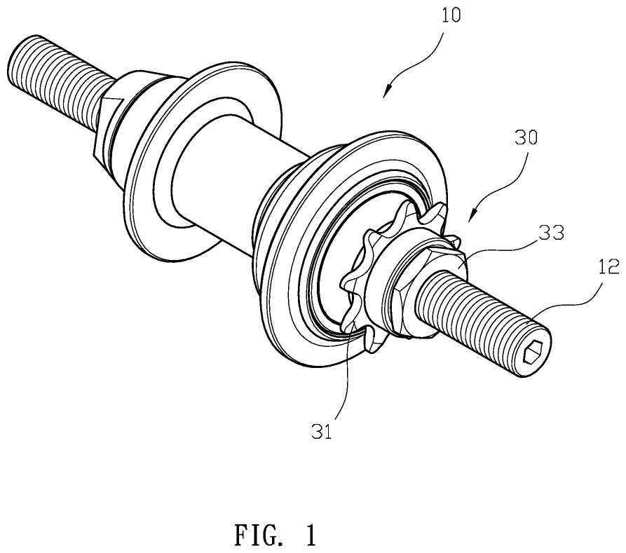

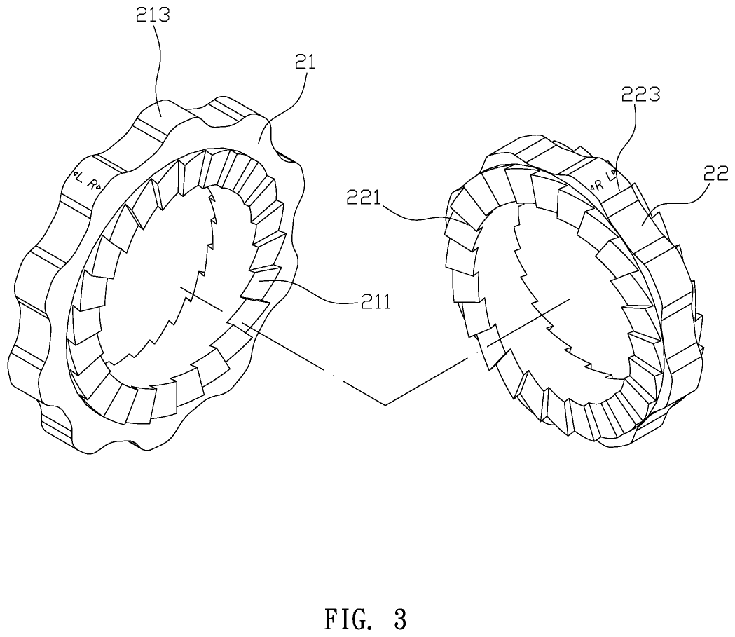

Referring to FIGS. 1 to 3, the present invention provides a bicycle hub apparatus which comprises a wheel hub (10), a freewheel (20) and a driving base (30). The wheel hub (10) has a housing (11) formed at an end thereof, and a shaft (12) axially penetrates through the housing (11) to pivotally connect to the wheel hub (10). Also, a connecting section (111) formed at an inner periphery of the housing (11) has a non-circular cross-section, and a driving ring (13) is coupled with the connecting section (111) in the housing (11). The driving ring (13) has a concave-convex inner periphery (131), and a locating ring (14) is tightly coupled in the housing (11) at a front end thereof so as to limit a position of the driving ring (13) in the connecting section (111). The freewheel (20) comprises a first chainwheel (21) and a second chainwheel (22), a first elastic piece (23) and a second elastic piece (24). A lateral surface of the first chainwheel (21) comprises a first teeth (211) while a lateral surface of the second chianwheel (22) has a third teeth (221), and the first teeth (211) is configured to engage with the third teeth (221) to have a synchronous rotation in clockwise direction. Also, the other lateral surface of the first chainwheel (21) has a second teeth (212) while the other lateral surface of the second chainwheel (22) comprises a fourth teeth (222) such that when the first chainwheel (21) and the second chainwheel (22) are turned over, the second teeth (212) is adapted to engage with the fourth teeth (222) to have a synchronous rotation in counterclockwise direction. Moreover, an outer periphery of the first chainwheel (21) has mark R and L thereon respectively located close to the first teeth (211) and the second teeth (212) while an outer periphery of the second chainwheel (22) has mark R and L thereon respectively located close to the third teeth (221) and the fourth teeth (222). The first elastic piece (23) and the second elastic piece (24) are formed in disc shape. The first elastic piece (23) has a plurality of first abutting portions (232) at one lateral surface thereof, and each of the first abutting portions (232) formed in flat shape and extended from an edge of the first elastic piece (23) is connected to a first elastic portion (231) which axially protrudes from the other lateral surface of the first elastic piece (23). Similarly, the second elastic piece (24) comprises a plurality of second abutting portions (242) at one lateral surface thereof, and each of the second abutting portions (242) formed in flat shape and extended from an edge of the second elastic piece (24) is connected to a second elastic portion (241) which axially protrudes from the other lateral surface of the second elastic piece (24). The first abutting portions (232) and the second abutting portions (242) are respectively abutted against the first chainwheel (21) and the second chainwheel (22) at the lateral sides which are not engaged. Also, the outer peripheries of the first chainwheel (21) and the second chainwheel (22) are respectively formed in a concave-convex first driving surface (213) and a concave-convex second driving surface (223). The first driving surface (213) is configured to engage with the inner periphery (131) of the driving ring (13). The driving base (30) is disposed on the shaft (12) of the wheel hub (10), and a driving gear (31) is formed at an outer periphery of the driving base (30). Moreover, a driving opening (32) axially penetrating through the driving base (30) comprises a concave-convex inner periphery. The driving opening (32) is configured to match and engage with the second driving surface (223) of the second chainwheel (22) through concave-convex engagement, and a nut (33) is locked on the shaft (12) to abut against and limit a position of the driving base (30).

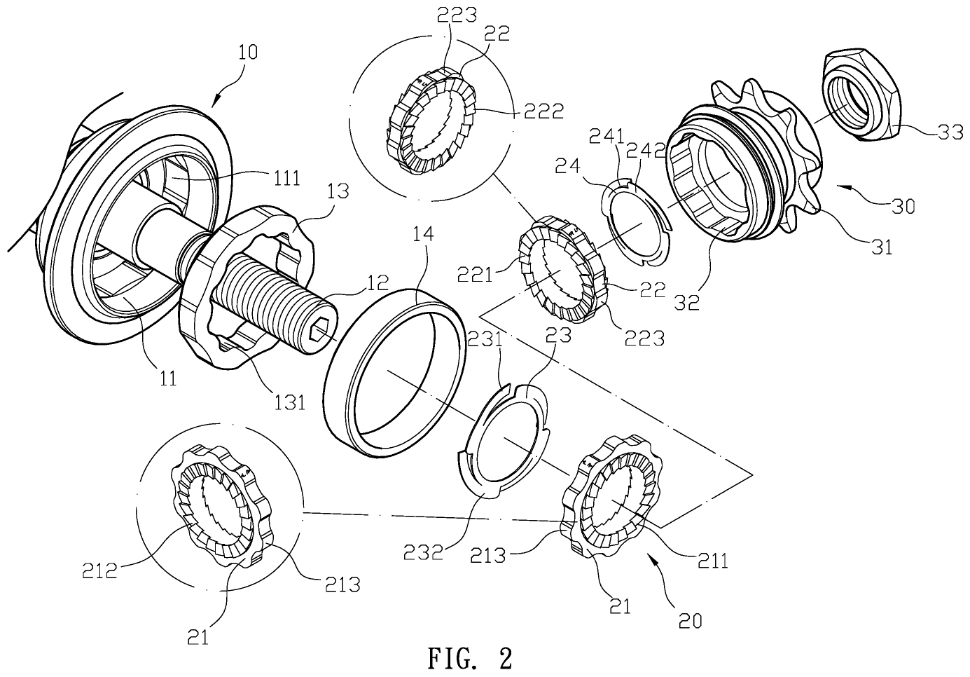

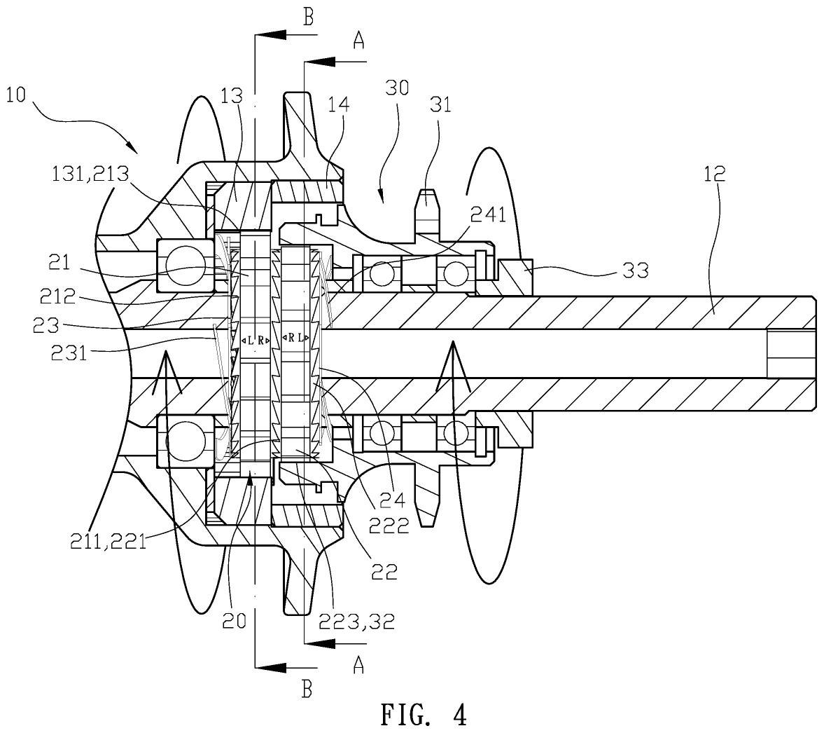

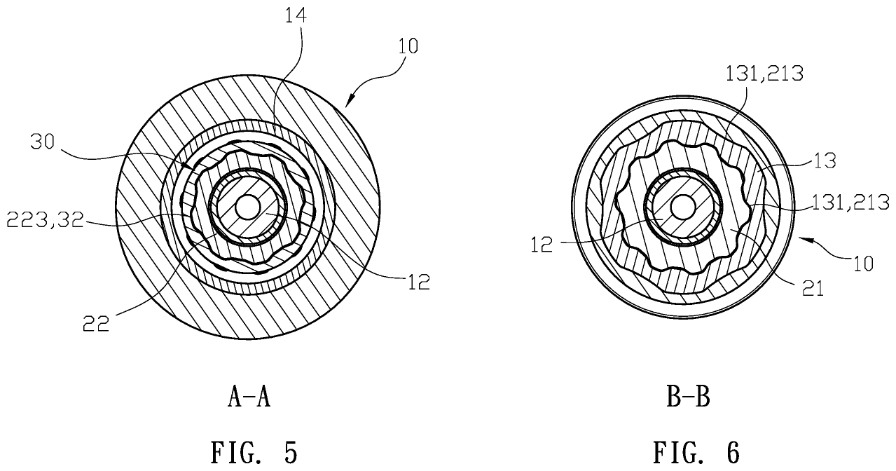

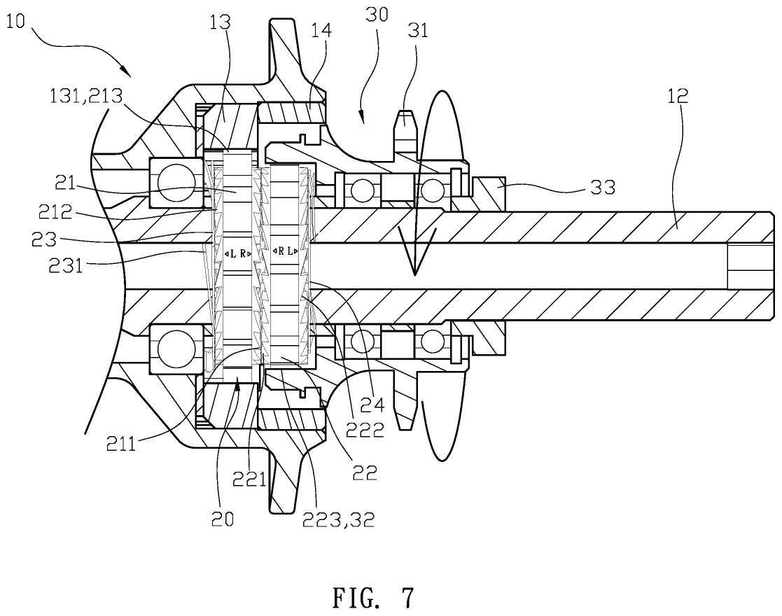

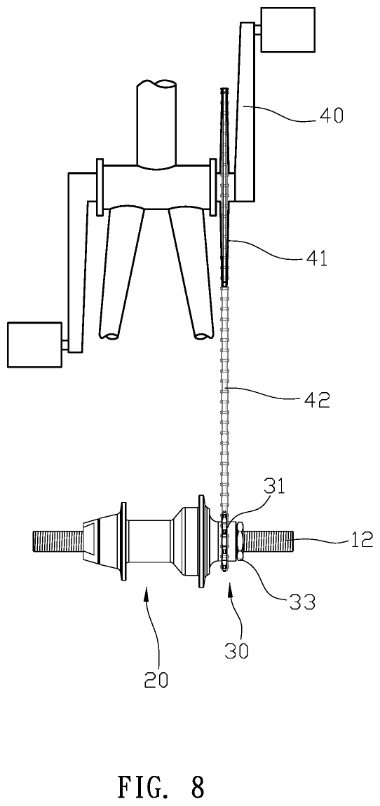

Structurally, referring to FIGS. 2 to 6, the driving ring (13) is engaged on the connecting section (111) of the housing (11) of the wheel hub (10), and the locating ring (14) is configured to abut against in the housing (11) at a front end thereof so as to limit a position of the driving ring (13). Thereafter, the first elastic piece (23) is positioned in the housing (11), and the first elastic portions (231) are faced to an inward space of the housing (11). Then, the first chainwheel (21) is installed in the housing (11), and the first teeth (211) is faced outwardly, and the first driving surface (213) is engaged with the inner periphery (131) of the driving ring (13) such that the chainwheel (21) and the driving ring (13) can have synchronous rotation. Additionally, the second teeth (212) of the first chainwheel (21) is borne against the first abutting portion (232) of the first elastic piece (23), and the second elastic portion (241) is faced inwardly when the second elastic piece (24) is installed into the driving base (30). After that, the second chainwheel (22) is installed in the driving base (30) while the third teeth (221) is faced outwardly, and the second driving surface (223) is engaged with the driving opening (32) so as to have synchronous rotation. Meanwhile, the fourth teeth (222) of the second chainwheel (22) is borne against the second abutting portion (242) of the second elastic piece (24). The first chainwheel (21) and the second chainwheel (22) are respectively positioned in the wheel hub (10) and the driving base (30), and the second teeth (212) and the fourth teeth (222) are respectively borne against the first abutting portion (232) and the second abutting portion (242). Subsequently, the shaft (12) of the wheel hub (10) penetrates through the driving base (30) to engage with the nut (33), and through pushing by the first elastic piece (23) and the second elastic piece (24), the first teeth (211) of the first chainwheel (21) and the third teeth (221) of the second chainwheel (22) which are faced toward each other are engaged together. Referring to FIGS. 7 and 8, when the driving base (30) have clockwise rotation to drive the wheel hub (10), a bicycle is configured to move forward. In this case, the driving base (30) is configured to be installed at a right side of the bicycle, and a sprocket (41) cooperating a bicycle chain (42) is configured to install on a crank arm (40) at the right side of the bicycle to drive the driving gear (31) of the driving base (30). Thus, in case that the bicycle moves forward, when a bicyclist pedals in a backward direction, the first teeth (211) of the first chainwheel (21) and the third teeth (221) of the second chainwheel (22) are disengaged with each other, thereby achieving the effect of one-way driving.

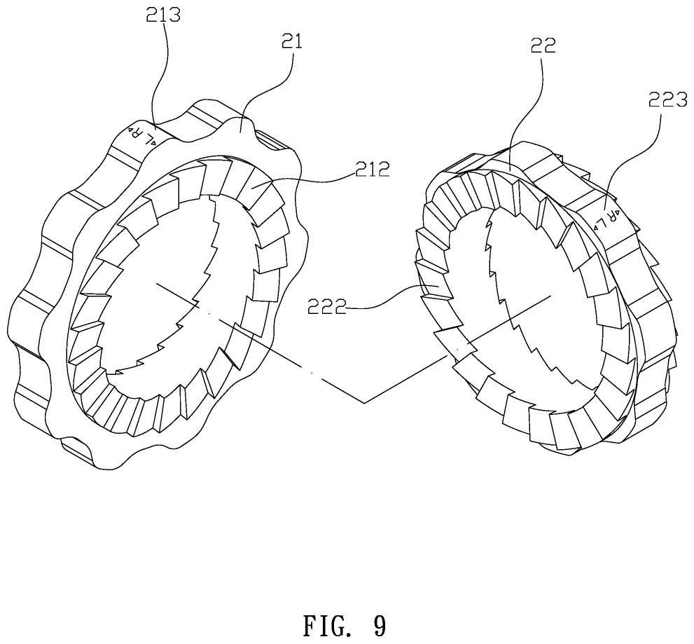

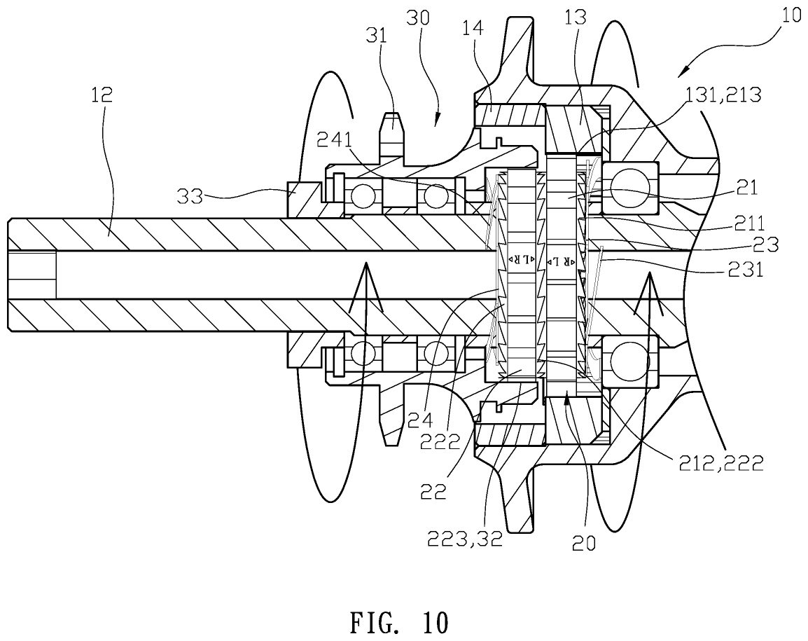

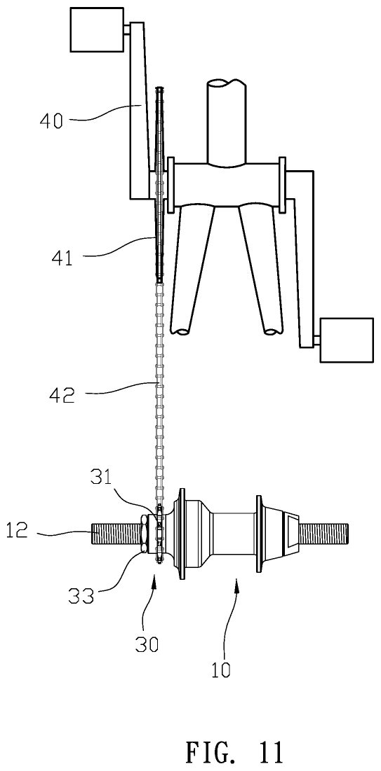

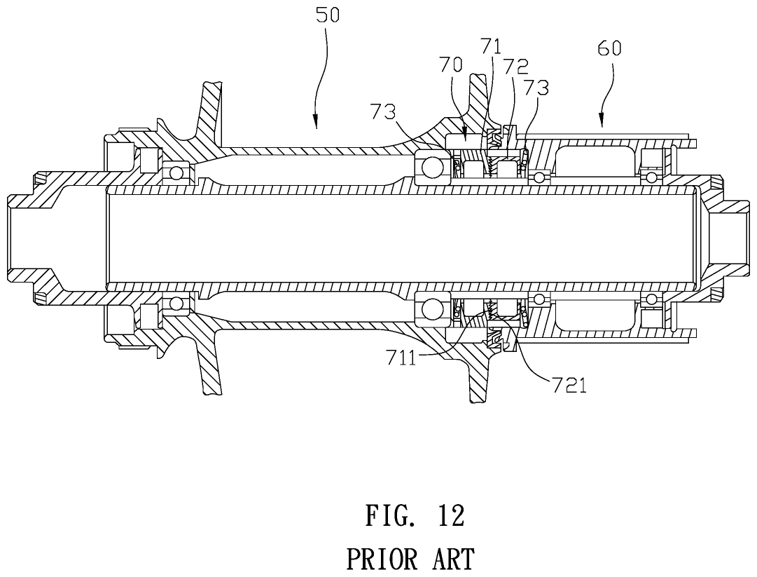

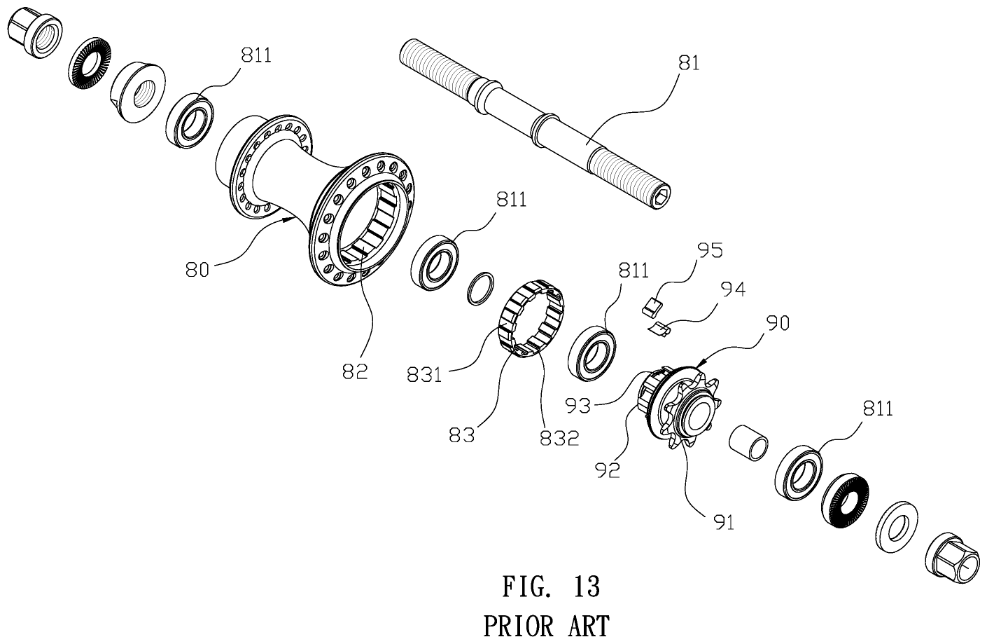

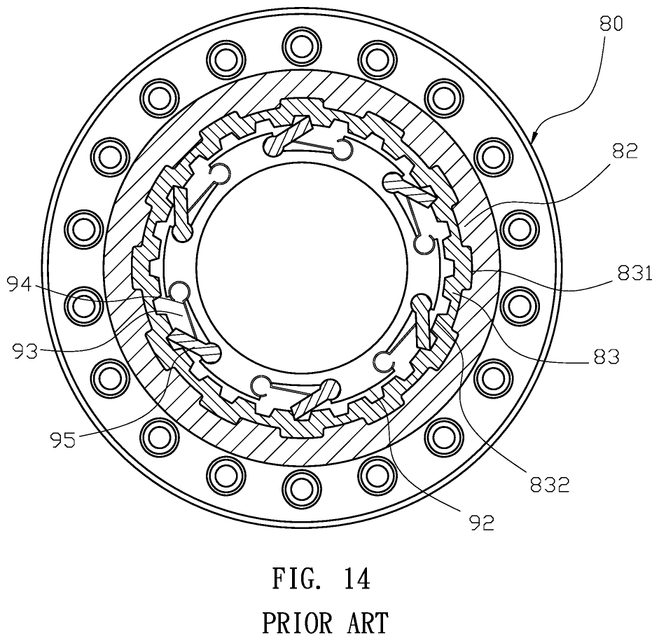

In another embodiment, referring to FIGS. 9 to 11, the sprocket (41) may be installed on the crank arm (40) at a left side of the bicycle to drive the driving gear (31) of the driving base (30). In case that a bicyclist directly turn the wheel hub (10) 180 degrees to install the driving base (30) at the left side of the bicycle, because of the engagement between the first teeth (211) and the third teeth (221), the wheel hub (10) is only driven by the driving base (30) in the clockwise direction, and when pedaling forward, the driving base (30) is configured to rotate in a counterclockwise direction and not drive the wheel hub (10). In this time, the driving base (30), the first chainwheel (21), and the second chainwheel (22) are detached from the wheel hub (10), and the first chainwheel (21) and the second chainwheel (22) are turned over to engage the second teeth (212) and the fourth teeth (222), and the first chainwheel (21), the second chainwheel (22), and the driving base (30) are installed back in the wheel hub (10) at the left side of the bicycle. Also, the first elastic piece (23) and the second elastic piece (24) are configured to push the first chainwheel (21) and the second chainwheel (22) to firmly engage together. Thus, when a bicyclist pedaling forward, the driving base (30) is configured to drive and have synchronous rotation in a counterclockwise direction with the wheel hub (10), and on the other hand, when the bicyclist pedaling backward, the second teeth (212) and the fourth teeth (222) are adapted to be disengaged with each other. Thus, the sprocket (41) cooperating the bicycle chain (42) is configured to install on a crank arm (40) at the left side of the bicycle to drive the driving gear (31) of the driving base (30), thereby achieving the effect of one-way driving.

Comparing with conventional bicycle hub apparatus, the present invention is advantageous because: (i) because of the first chainwheel (21) and the second chainwheel (22) having the first teeth (211), the second teeth (212), the third teeth (221), and the fourth teeth (222), the wheel hub (11) can be installed at the left or the right side of the bicycle, which is convenient; (ii) the first elastic piece (23) and the second elastic piece (24) respectively have the first abutting portion (232) and the second abutting portion (242) which are flat, and the first abutting portion (232) and the second abutting portion (242) are respectively and evenly borne against at outer surfaces of the first chainwheel (21) and the second chainwheel (22), which improves the engagement of the first chainwheel (21) and the second chainwheel (22) and prevents the first chainwheel (21) and the second chainwheel (22) from being damaged by the first elastic portion (231) and the second elastic portion (241); and (iii) the first driving surface (213) and the inner periphery (131) of the driving ring (13), and the second driving surface (223) and the driving opening (32) respectively have concave-convex peripheries, which enhances the engagement between the first driving surface (213) and the inner periphery (131) of the driving ring (13) and between the second driving surface (223) and the driving opening (32) and prevent the parts from wearing or stuck by sharp edges, thereby achieving the effect of stable and safe riding.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A bicycle hub apparatus comprising,
a wheel hub having a housing formed at an end thereof, and a shaft axially penetrating through the housing to pivotally connect to the wheel hub; a connecting section, which is formed at an inner periphery of the housing, having a non-circular cross-section, and a driving ring coupled with the connecting section in the housing, and the driving ring having a concave-convex inner periphery;
a freewheel comprising a first chainwheel and a second chainwheel, a first elastic piece, and a second elastic piece; a lateral surface of the first chainwheel comprising a first teeth while a lateral surface of the second chianwheel having a third teeth, and the first teeth configured to engage with the third teeth to have a synchronous rotation in clockwise direction; the other lateral surface of the first chainwheel having a second teeth while the other lateral surface of the second chainwheel comprising a fourth teeth such that when the first chainwheel and the second chainwheel rolled over, the second teeth adapted to engage with the fourth teeth to have a synchronous rotation in counterclockwise direction; the first elastic piece and the second elastic piece formed in disc shape; the first elastic piece having a plurality of first abutting portions at one lateral surface thereof, and each of the first abutting portions, which is formed in flat shape and extended from an edge of the first elastic piece, connected to a first elastic portion which axially protrudes from the other lateral surface of the first elastic piece; the second elastic piece comprising a plurality of second abutting portions at one lateral surface thereof, and each of the second abutting portions, which is formed in flat shape and extended from an edge of the second elastic piece, connected to a second elastic portion which axially protrudes from the other lateral surface of the second elastic piece; the first abutting portions and the second abutting portions respectively abutted against the first chainwheel and the second chainwheel at the lateral sides which are not engaged; outer peripheries of the first chainwheel and the second chainwheel respectively formed in a concave-convex first driving surface and a concave-convex second driving surface; the first driving surface configured to engage with the inner periphery of the driving ring; and
a driving base disposed on the shaft of the wheel hub, and a driving gear formed at an outer periphery of the driving base; a driving opening, which axially penetrates through the driving base, comprising a concave-convex inner periphery; the driving opening configured to engage with the second driving surface of the second chainwheel, and a nut locked on the shaft to abut against and limit a position of the driving base.

2. The bicycle hub apparatus of claim 1, wherein the concave-convex inner periphery of the driving ring is configured to match and engage with the concave-convex first driving surface of the first chainwheel.

3. The bicycle hub apparatus of claim 1, wherein the driving opening having the concave-convex inner periphery is adapted to match and engage with the concave-convex second driving surface of the second chainwheel.

4. The bicycle hub apparatus of claim 1, wherein the outer periphery of the first chainwheel has mark R and L thereon respectively located close to the first teeth and the second teeth while the outer periphery of the second chainwheel has mark R and L thereon respectively located close to the third teeth and the fourth teeth.

5. The bicycle hub apparatus of claim 1, wherein a locating ring is tightly coupled in the housing at a front end thereof so as to limit a position of the driving ring in the connecting section.
